(19) United States
(12) Patent Application Publication
(10) Pub. No.: US 2024/0390852 A1
(43) Pub. Date: Nov. 28, 2024

(54) USE OF OFF-GASES RICH IN CARBON MONOXIDE AS FEEDSTOCKS IN STEAM REFORMERS

(71) Applicant: Linde GmbH, Pullach (DE)

(72) Inventors: Martin LANG, Pullach (DE); Alexander MAIER, Pullach (DE); Florian ETTNER, Pullach (DE)

(21) Appl. No.: 18/685,563

(22) PCT Filed: Jul. 7, 2022
(86) PCT No.: PCT/EP2022/025317

§ 371 Date: Feb. 22, 2024

(30) Foreign Application Priority Data
Aug. 27, 2021 (EP) 21020428.5

(51) Int. Cl. B01D 53/86; B01J 19/24; C01B 3/12; C01B 3/34; C10J 1/26

(52) U.S. Cl. CPC B01D 53/8612; B01J 19/245; C01B 3/12; C01B 3/34; C10J 1/26; B01D 2257/304; C01B 2203/0233; C01B 2203/0283; C01B 2203/127; C01B 2203/1276; C01B 2203/143

(57) ABSTRACT

A method and device for the material use of an off-gas which is rich in carbon monoxide and contains hydrocarbons as well as hydrogenatable sulfur compounds, wherein a sulfur-free reformer feed is formed using the off-gas and is subsequently converted by steam reforming into a hydrogen-containing synthesis gas. According to the invention, the off-gas which is rich in carbon monoxide and contains hydrocarbons as well as hydrogenatable sulfur compounds is heated and subjected to hydrolysis at a temperature between 150 and 250° C., preferably between 150 and 190° C., in order to convert the hydrogenatable sulfur compounds with catalytic support into hydrogen sulfide, and to obtain an off-gas which is free of hydrogenatable sulfur compounds and which is subsequently desulfurized over a fixed bed containing zinc oxide.

The invention relates to a method for the material use of an off-gas which is rich in carbon monoxide and contains hydrocarbons as well as to hydrogenatable sulfur compounds, wherein a sulfur-free reformer feed is formed using the off-gas and is subsequently converted by steam reforming into a hydrogen-containing synthesis gas.

The invention also relates to a device for carrying out the method according to the invention.

In the context of the present text, the term “hydrogenatable sulfur compounds” is understood to mean sulfur compounds which can be converted into hydrogen sulfide with hydrogen or water.

A person skilled in the art uses the term “off-gases” to refer to gas mixtures which are obtained as by-products in industrial processes. In particular, the processing of fossil or biogenic energy carriers in refineries results in off-gases, which are rich in carbon monoxide and contain hydrocarbons as well as hydrogenatable sulfur compounds, such as, for example, carbonyl sulfide. Such off-gases are also known as “refinery gases.” According to the prior art, such off-gases, which typically comprise between 3 and 25 mol % carbon monoxide and more than 10 mol % hydrocarbons, and can consist of more than 30 mol % hydrogen, are predominantly used to generate energy, for which purpose they are used, either completely or after hydrogen has been removed, as combustion gases in furnaces, in order to generate, for example, process steam or to supply heat for a chemical reaction.

In addition, it is endeavored to use off-gases, such as refinery gases, as materials, since the hydrocarbons contained in them constitute valuable resources whose economic potential can only be achieved to a small extent during thermal utilization. For example, the reaction of refinery gases in a steam reformer in order to obtain hydrogen is known. In this case, a main feed, which contains hydrocarbons and is, for example, natural gas, liquid gas or naphtha, is preheated to a temperature between 250 and 400° C. after the admixture of refinery gas, and subsequently subjected to hydrogenation in order to convert sulfur compounds with catalytic support to hydrogen sulfide. In order to desulfurize it, the gas mixture obtained in the hydrogenation is passed over a fixed bed which contains zinc oxide with which the hydrogen sulfide reacts to form water and zinc sulfide, which remains in the fixed bed. In order to avoid soot formation in the steam reformer resulting from the thermal decomposition of hydrocarbons with more than one carbon atom, desulfurization can follow a pre-reforming process. In this case, the desulfurized gas mixture is supplied to a pre-reformer in which hydrocarbons with more than one carbon atom are converted, with the addition of steam, to methane. After addition of further steam, the optionally pre-reformed gas mixture having a sulfur content of less than 0.1 ppmv is obtained as a sulfur-free reformer feed, which is supplied to the steam reformer after heating in a feed superheater at a temperature between 500 and 650° C.

In order to be able to realize the devices used for hydrogenation and desulfurization, and optionally also the devices used for pre-reforming, in a compact and cost-effective manner, in most instances steam is added downstream of said devices. The problem here is that carbon monoxide present in the refinery gas already decomposes during the dry pre-heating upstream of the hydrogenation reactor, but also in the hydrogenation reactor itself as well as in downstream apparatuses, and forms soot which the catalysts used further downstream can displace. In addition, carbon monoxide is methanized under hydrogenation conditions and in the presence of large amounts of hydrogen with strong heat release.

To ensure that the soot formation does not exceed an acceptable level and the maximum permissible temperature of the catalyst used in the hydrogenation reactor is not exceeded, the quantity of refinery gas that can be admixed with the main feed is very limited, so that typically only a small portion of the refinery gases occurring in a refinery can be used as materials, whilst the larger portion has to be burned either in the combustion chamber of the steam reformer or at another point.

Industrial processes, such as the refining of oils, in which off-gases which are rich in carbon monoxide and contain hydrocarbons as well as hydrogenatable sulfur compounds are obtained, are increasingly being optimized for minimal steam production or minimal carbon dioxide emissions. The available amounts of off-gas thus often exceed the amounts of fuel gas that can be used in the processes, so that there is a need for alternative possibilities for use.

The object of the present invention is therefore to specify a method of the generic type and a device for its implementation, which enable a larger portion of the off-gases occurring in an industrial process to be used as materials than is possible according to the prior art.

According to the method, this object is achieved according to the invention in that the off-gas which is rich in carbon monoxide and contains hydrocarbons as well as hydrogenatable sulfur compounds is heated and subjected to hydrolysis at a temperature between 150 and 250° C., preferably between 150 and 190° C., in order to convert the hydrogenatable sulfur compounds with catalytic support into hydrogen sulfide, and to obtain an off-gas which is free of hydrogenatable sulfur compounds and which is subsequently desulfurized over a fixed bed containing zinc oxide.

During hydrolysis, the hydrogenatable sulfur compounds are cleaved with water in a catalytically assisted reaction. A minimum water content is required so that all the hydrogenatable sulfur compounds can be converted into hydrogen sulfide. If the water content of the off-gas is less than this minimum value, steam is supplied upstream of the hydrolysis so that the minimum water content is achieved.

In contrast to hydrogenation, under the process conditions of the hydrolysis carbon monoxide is not methanized, which means that, even if the off-gas has a large carbon monoxide content, the temperature increases only insignificantly and remains in a range in which carbon monoxide does not thermally decompose. Soot formation in the reactor used for hydrolysis can thus be reliably avoided.

To adjust the temperature required for the hydrolysis, it is proposed to heat the off-gas in indirect heat exchange with condensing steam, which is present at a pressure between 10 and 15 bar. The steam is preferably not superheated, so that the temperature at which the off-gas is supplied to the hydrolysis is determined by the condensation temperature of the steam which is very precisely and easily controllable via the pressure. Alternatively, the temperature can also be set via electric heating or by heat transfer from another process medium.

The off-gas is passed to the desulfurization at the temperature reached during the hydrolysis. Since the reaction of zinc oxide with hydrogen sulfide to form water and zinc sulfide does not lead to any significant temperature change, there is also no risk of soot formation due to thermal carbon monoxide decomposition.

However, soot could be formed if the temperature is raised during the further treatment of the desulfurized off-gas. To ensure that soot is not produced or is only produced to a small extent here, it is proposed that the carbon monoxide partial pressure in the desulfurized off-gas be reduced before heating by admixing steam. The total amount of steam still required in the further process is preferably supplied to the desulfurized off-gas before its temperature is raised to more than 250° C.

In order to convert hydrocarbons having more than two carbon atoms present in the desulfurized off-gas into methane and to reduce its carbon monoxide content, the desulfurized off-gas can be subjected to pre-reforming, for which purpose it is heated after the admixture of steam and supplied to a pre-reformer at a temperature between 300 and 500° C., preferably between 350 and 450° C. The pre-reforming results in the sulfur-free reformer feed being obtained, which is subsequently heated to a temperature between 500 and 650° C. and supplied to the steam reforming.

One embodiment of the method according to the invention provides for the sulfur-free reformer feed to be formed using the off-gas which is rich in carbon monoxide and contains hydrocarbons as well as hydrogenatable sulfur compounds and at least one feed which contains hydrogenatable sulfur compounds, which may also be the main feed of the method. The further feed, which is, for example, natural gas, liquid gas or naphtha, has a lower carbon monoxide content than the off-gas, which is why it is hydrogenated as described above and desulfurized over a fixed bed containing zinc oxide before it is combined with the off-gas desulfurized according to the invention and optionally subjected to pre-reforming together with said off-gas. After its desulfurization, the further feed is present at a temperature of up to 400° C., so that, in order to avoid or suppress soot formation, the entire amount of steam still required in the further process is expediently admixed with the desulfurized off-gas before being combined with the desulfurized further feed.

Under certain circumstances, the carbon monoxide content of the off-gas is so high that the amount of steam that can be used in the process is not sufficient to prepare the desulfurized off-gas for the sulfur-free reformer feed without substantial soot formation. In this case, an embodiment of the method according to the invention provides for the carbon monoxide content of the off-gas to be reduced by means of a water-gas shift arranged downstream of the desulfurization and upstream of the pre-reforming or steam reforming. A portion of the available quantity of process steam is preferably admixed with the desulfurized off-gas upstream of the water-gas shift, so that a steam-to-gas ratio between 0.3 and 1.0 (on a molar basis) is achieved.

If the off-gas which is rich in carbon monoxide and contains hydrocarbons as well as hydrogenatable sulfur compounds has a high hydrogen content of more than 50 mol %, an expedient variant of the invention provides for the hydrogen content of the off-gas upstream of the steam reformer to be reduced to less than 50 mol % in order to relieve the steam reformer. For this purpose, hydrogen is preferably removed from the off-gas upstream of the hydrolysis. If the off-gas is available at a sufficiently high pressure, the hydrogen can be removed via a membrane, wherein a hydrogen-rich permeate and an off-gas with a reduced hydrogen content are obtained as a retentate. The hydrogen-rich permeate can be supplied directly or after compression to a pressure swing adsorber to obtain a hydrogen product, while the off-gas, which has a reduced hydrogen content, is further processed to form a sulfur-free reformer feed.

Irrespective of its pressure, the off-gas can also be treated by pressure swing adsorption, wherein the off-gas, which has a reduced hydrogen content, is obtained with low pressure as residual gas.

Furthermore, the invention relates to a device for the material use of an off-gas which is rich in carbon monoxide and contains hydrocarbons as well as to hydrogenatable sulfur compounds, having a treatment device for forming a sulfur-free reformer feed using the off-gas and a steam reformer in which the sulfur-free reformer feed can be converted by steam reforming into a hydrogen-containing synthesis gas.

According to the invention, the stated object is achieved in that the treatment device comprises a first heating device, a hydrolyzer, and a fixed bed containing zinc oxide, which are arranged in such a way that they can be flowed through in series by the off-gas in order to heat the off-gas to a temperature between 150 and 250° C., preferably between 150 and 190° C., and to subsequently subject it to hydrolysis in which an off-gas which is free of hydrogenatable sulfur compounds is obtained and subsequently desulfurized over the fixed bed containing zinc oxide.

In a preferred embodiment of the device according to the invention, the first heating device arranged upstream of the hydrolyzer is designed as a condenser in which the off-gas can be heated in indirect heat exchange with condensing medium pressure steam.

A further preferred embodiment of the device according to the invention provides a pre-reformer arranged as part of the treatment device downstream of the fixed bed containing zinc oxide, in which pre-reformer the desulfurized off-gas can be subjected to pre-reforming in which hydrocarbons having more than two carbon atoms are converted to methane and the carbon monoxide content of the off-gas is reduced.

A second heating device, via which the desulfurized off-gas can be heated to a temperature between 300 and 500° C., preferably between 350 and 450° C., at which it is supplied to the pre-reformer, is expediently placed upstream of the pre-reformer and downstream of the fixed bed containing zinc oxide.

Expediently, a first mixing device is provided between the fixed bed containing zinc oxide and the second heating device, via which first mixing device steam can be admixed with the desulfurized off-gas in order to prevent or at least suppress the thermal decomposition of carbon monoxide during heating as well as soot deposits in the heating device and in the plant components following in the direction of flow of the off-gas.

In another preferred embodiment, the treatment device of the device according to the invention comprises a third heating device, a hydrogenation reactor, and a further fixed bed containing zinc oxide, which are arranged in such a way that they can be flowed through in series by a further feed comprising hydrocarbons as well as hydrogenatable sulfur compounds, in order to heat the further feed to a temperature between 250 and 400° C. and to subject said further feed to a hydrogenation in which hydrogenatable sulfur compounds contained in the further feed are converted to hydrogen sulfide which is subsequently removed over the further fixed bed containing zinc oxide.

In this embodiment of the device according to the invention, a second mixing device connected to the further fixed bed containing zinc oxide is expediently arranged downstream of the first mixing device, via which mixing device the desulfurized off-gas which is mixed with steam can be combined with the desulfurized further feed.

In a further embodiment of the device according to the invention, the treatment device comprises a shift reactor arranged downstream of the fixed bed containing zinc oxide and upstream of the pre-reforming or steam reforming, in which shift reactor the desulfurized off-gas can be subjected to a water-gas shift.

The treatment device can also comprise a membrane unit or a pressure swing adsorber by means of which the hydrogen can be removed from the off-gas upstream of the steam reformer.

The treatment device further comprises a feed superheater arranged upstream of the steam reformer in which the sulfur-free reformer feed formed using the desulfurized off-gas can be heated to a temperature between 50° and 650° C.

By means of the invention, it is possible to use off-gases which are rich in carbon monoxide and contain hydrocarbons as well as hydrogenatable sulfur compounds in a steam reforming process as the main feed or even as the sole feed.

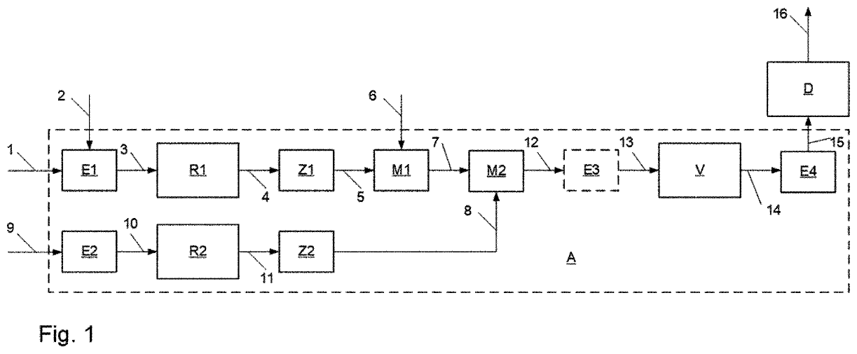

The invention is explained in more detail below using an exemplary embodiment schematically illustrated in FIG. 1.

FIG. 1 shows an embodiment of the invention in which an off-gas which is rich in carbon monoxide and contains hydrocarbons as well as hydrogenatable sulfur compounds is processed together with a further feed which contains hydrogenatable sulfur compounds and hydrocarbons to form a sulfur-free reformer feed.

An off-gas which is rich in carbon monoxide and contains hydrocarbons as well as hydrogenatable sulfur compounds such as, for example, carbonyl sulfide, which is, for example, a refinery gas, is supplied via line 1 to a heating device E1 arranged in the treatment device A, where it is heated to a temperature between 150 and 250° C. in indirect heat exchange with condensing medium pressure steam 2. The heated off-gas 3 is subsequently subjected in the reactor R1 to hydrolysis in which the hydrogenatable sulfur compounds are converted to hydrogen sulfide, and an off-gas 4 which is free of hydrogenatable sulfur compounds is obtained and is guided over the fixed bed Z1 containing zinc oxide for it to be desulfurized. There is no substantial energy release during the hydrolysis or during the desulfurization, so that carbon monoxide contained in the off-gas 1 does not thermally decompose and form soot. In order to prevent or at least suppress soot formation in the further method steps, the desulfurized off-gas 5 is mixed in the first mixing device M1 with the entire amount of steam 6 that can still be used in the further process before said off-gas is supplied via line 7 to the second mixing device M2 in order to be combined there with a desulfurized further feed 8, which has a temperature between 250 and 400° C.

The further feed 9, which is, for example, natural gas, likewise contains hydrogenatable sulfur compounds and hydrocarbons, but has a substantially lower carbon monoxide content than the off-gas 1. After heating in the heating device E2, it is supplied via line 10 at a temperature between 250 and 400° C. to the hydrogenation reactor R2 in order to convert hydrogenatable sulfur compounds to hydrogen sulfide and to obtain a hydrogenated further feed 11 which is desulfurized in a further fixed bed Z2 containing zinc oxide.

If the temperature of the material mixture 12 formed in the second mixing device M2 from the desulfurized feeds 5 and 8 and steam 6 is not sufficient to be supplied directly to the pre-reformer V, the substance mixture 12 in the heating device E3 is heated to a temperature between 300 and 500° C. before it is supplied via line 13 to the pre-reformer V in order to convert hydrocarbons with more than one carbon atom to methane and to obtain a sulfur-free reformer feed 14, which is heated in the feed superheater E4 to a temperature between 500 and 650° C. and is introduced via line 15 into the steam reformer D to be converted into a hydrogen-containing synthesis gas 16.

1. A method for the material use of an off-gas which is rich in carbon monoxide and contains hydrocarbons as well as hydrogenatable sulfur compounds, wherein a sulfur-free reformer feed is formed using the off-gas and subsequently converted by steam reforming into a hydrogen-containing synthesis gas, wherein the off-gas which is rich in carbon monoxide and contains hydrocarbons as well as hydrogenatable sulfur compounds is heated and subjected to hydrolysis at a temperature between 150 and 250° C., preferably between 150 and 190° C., in order to convert the hydrogenatable sulfur compounds with catalytic support into hydrogen sulfide, and to obtain an off-gas which is free of hydrogenatable sulfur compounds and which is subsequently desulfurized over a fixed bed containing zinc oxide.

2. The method according to claim 1, wherein off-gas which is rich in carbon monoxide and contains hydrocarbons as well as hydrogenatable sulfur compounds is heated to the temperature required for the hydrolysis in indirect heat exchange with condensing medium pressure steam.

3. The method according to claim 1, wherein the desulfurized off-gas is heated to a temperature between 300 and 500° C. after the admixture of steam, and is subjected to pre-reforming in which the sulfur-free reformer feed is produced.

4. The method according to claim 1, wherein the sulfur-free reformer feed is formed using the off-gas which is rich in carbon monoxide and contains hydrocarbons as well as hydrogenatable sulfur compounds and a further feed which contains a further hydrocarbon as well as hydrogenatable sulfur compounds, wherein the further feed is hydrogenated and desulfurized over a fixed bed containing zinc oxide before it is combined with the desulfurized off-gas and subjected to pre-reforming together therewith.

5. The method according to claim 4, wherein the desulfurized off-gas is combined with the desulfurized further feed after the admixture of steam.

6. The method according to claim 1, wherein the desulfurized off-gas is subjected to a water-gas shift.

7. The method according to claim 1, wherein hydrogen is removed from the off-gas.

8. A device for the material use of an off-gas which is rich in carbon monoxide and contains hydrocarbons as well as hydrogenatable sulfur compounds, comprising a treatment device for forming a sulfur-free reformer feed using the off-gas and a steam reformer, in which the sulfur-free reformer feed can be converted by steam reforming into a hydrogen-containing synthesis gas, wherein the treatment device comprises a first heating device, a hydrolyzer and a fixed bed containing zinc oxide, which are arranged in such a way that they can be flowed through in series by the off-gas in order to heat the off-gas to a temperature between 150 and 250° C., preferably between 150 and 190° C., and to subsequently subject it to hydrolysis in which an off-gas which is free of hydrogenatable sulfur compounds is obtained and then desulfurized over the fixed bed containing zinc oxide.

9. The device according to claim 8, wherein the first heating device arranged upstream of the hydrolyzer is designed as a condenser in which the off-gas which is rich in carbon monoxide and contains hydrocarbons as well as hydrogenatable sulfur compounds can be heated in indirect heat exchange with condensing medium pressure steam.

10. The device according to claim 9, wherein the treatment device comprises a pre-reformer arranged downstream of the fixed bed containing zinc oxide, in which pre-reformer the desulfurized off-gas can be subjected to pre-reforming in which hydrocarbons having more than two carbon atoms are converted to methane.

11. The device according to claim 10, wherein a second heating device, via which the desulfurized off-gas can be heated to a temperature between 300 and 500° C., preferably between 350 and 450° C., is placed upstream of the pre-reformer and downstream of the fixed bed containing zinc oxide.

12. The device according to claim 8, wherein a first mixing device is provided between the fixed bed containing zinc oxide and the second heating device, via which mixing device steam can be admixed to the desulfurized off-gas

13. The device according to claim 8, wherein the treatment device of the device according to the invention comprises a third heating device, a hydrogenation reactor, and a further fixed bed containing zinc oxide, which are arranged in such a way that they can be flowed through in series by a further feed comprising hydrocarbons as well as hydrogenated sulfur compounds, in order to heat the further feed to a temperature between 250 and 400° C. and to subject said further feed to a hydrogenation in which hydrogenated sulfur compounds contained in the further feed are converted to hydrogen sulfide which is subsequently removed over the further fixed bed containing zinc oxide.

14. The device according to claim 13, wherein a second mixing device connected to the further fixed bed containing zinc oxide is arranged downstream of the first mixing device, via which mixing device the desulfurized off-gas which is mixed with steam can be combined with the desulfurized further feed.

15. The device according to claim 8, wherein it comprises a shift reactor arranged downstream of the fixed bed containing zinc oxide and upstream of the pre-reforming or steam reforming, in which shift reactor the desulfurized off-gas can be subjected to a water-gas shift.
